(19) United States
(12) Patent Application Publication
(10) Pub. No.: US 2025/0393085 A1
(43) Pub. Date: Dec. 25, 2025

(54) TRANSPORTING MEDIA DATA ACCORDING TO USER-SELECTED PROCESSING DURING A MEDIA CALL

(71) Applicant: QUALCOMM Incorporated, San Diego, CA (US)

(72) Inventors: Imed Bouazizi, Celina, TX (US); Thomas Stockhammer, Bergen (DE); Liangping Ma, San Diego, CA (US)

(21) Appl. No.: 19/240,095

(22) Filed: Jun. 17, 2025

Related U.S. Application Data
(60) Provisional application No. 63/662,716, filed on Jun. 21, 2024.

(51) Int. Cl. H04W 76/14; H04L 65/1073; H04L 65/75

(52) U.S. Cl. CPC H04W 76/14; H04L 65/1073; H04L 65/765

(57) ABSTRACT

An example first user equipment (UE) device for communicating media data includes: a memory configured to store media data; and a processing system implemented in circuitry and configured to: establish a media communication session with a second UE device; request that an intermediate network device perform one or more media processing tasks on media data destined for the second UE device and originating from the first UE device, the intermediate network device being between the first UE device and the second UE device; and send the media data of the media communication session destined for the second UE device to the intermediate network device to cause the intermediate network device to perform the one or more media processing tasks on the media data.

This application claims the benefit of U.S. Provisional Application No. 63/662,716, filed Jun. 21, 2024, the entire contents of which are hereby incorporated by reference.

### TECHNICAL FIELD

This disclosure relates to transport of media data, and more particularly, to processing media data exchanged during a media communication session.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After media data has been encoded, the media data may be packetized for transmission or storage. The video data may be assembled into a media file conforming to any of a variety of standards, such as the International Organization for Standardization (ISO) base media file format and extensions thereof.

### SUMMARY

In general, this disclosure describes techniques for processing and communicating media data. In particular, various processes may be performed on or during an extended reality (XR) communication session or other IP Multimedia Subsystem (IMS) communication sessions. Such processes may include, for example, filtering media data (e.g., applying one or more visual effects to rendered media data), adding timed text (e.g., closed captioning and/or real-time translations) to the media data, translating audio data between languages, processing audio data in one language to generate closed caption data in another language, or the like. These processes are often processor-intensive, and may be performed using artificial intelligence/machine learning (AI/ML) techniques, such as natural language processing (NLP). Therefore, these processes may require processing by a network device, such as a media function (MF) or multimedia resource function (MRF) (MF/MRF) device. This disclosure describes various techniques for enabling (e.g., signaling availability and/or use of) such processes and performing such processes during a media communication session. In this manner, rather than a battery-powered device performing such processes during a real-time media communication session, the processes can be performed by a network device that has access to greater amounts of processing power without being limited by a battery.

In this manner, these techniques allow for selective enablement, configuration, modification, and/or deactivation of processing tasks performed by intermediate network devices (that is, devices not actively participating in a media communication session) during the media communication session. In this manner, such processing tasks may be enabled or disabled by a user device during the media communication session, and cause the intermediate network device to perform the task(s), which may preserve processing power and battery power on behalf of the user device.

In one example, a method of communicating media data includes: establishing, by a first user equipment (UE) device, a media communication session with a second UE device; executing, by the first UE device, a web application to configure an intermediate network device to perform one or more media processing tasks on media data destined for the second UE device and originating from the first UE device, the intermediate network device being between the first UE device and the second UE device; and sending, by the first UE device, the media data of the media communication session destined for the second UE device to the intermediate network device to cause the intermediate network device to perform the one or more media processing tasks on the media data.

In another example, a first user equipment (UE) device for communicating media data includes: a memory configured to store media data; and a processing system implemented in circuitry and configured to: establish a media communication session with a second UE device; execute a web application to configure an intermediate network device to perform one or more media processing tasks on media data destined for the second UE device and originating from the first UE device, the intermediate network device being between the first UE device and the second UE device; and send the media data of the media communication session destined for the second UE device to the intermediate network device to cause the intermediate network device to perform the one or more media processing tasks on the media data.

In another example, a first user equipment (UE) device for communicating media data includes: means for establishing a media communication session with a second UE device; means for executing a web application to configure an intermediate network device to perform one or more media processing tasks on media data destined for the second UE device and originating from the first UE device, the intermediate network device being between the first UE device and the second UE device; and means for sending the media data of the media communication session destined for the second UE device to the intermediate network device to cause the intermediate network device to perform the one or more media processing tasks on the media data.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example network including various devices for performing the techniques of this disclosure.

FIG. 2 is a block diagram illustrating an example computing system that may perform techniques of this disclosure.

FIG. 3 is a flowchart illustrating an example method of performing split rendering according to techniques of this disclosure.

FIG. 4 is a flowchart illustrating an example method of communicating media data according to the techniques of this disclosure.

FIG. 5 is a block diagram illustrating an example architecture that may be used to support IP Multimedia Subsystem (IMS) data channels per techniques of this disclosure.

FIG. 6 is a flow diagram illustrating an example method for mapping various media processing tasks to devices of an IMS per techniques of this disclosure.

FIG. 7 is a flowchart illustrating an example method of enabling media processing tasks for media data of a media communication session according to techniques of this disclosure.

### DETAILED DESCRIPTION

In general, this disclosure describes techniques for performing various techniques related to processing of media data exchanged during a media communication session, such as during an IP Multimedia Subsystem (IMS) call. Such media data may include augmented reality (AR) data, video data, image data, audio data, timed text data, or the like. The techniques of this disclosure may support various use cases.

As one example, during an IMS call between two or more users, one user may decide to activate an image filter to change their appearance during the call (e.g., to add a virtual object such as a hat or glasses, to modify foreground and/or background elements, or the like). Additionally or alternatively, a user may request that a real-time language translation service be activated, e.g., to present real-time closed captions of ongoing audio data or to directly translate one audio language to another.

Multimedia Telephony may use the IMS system. With the rise of artificial intelligence and machine learning (AI/ML), more and more sophisticated real-time processing is becoming possible. For consistent user experiences, these processing tools may be offered by the IMS network or other network devices that support media communication sessions. Such intermediate network devices may better fulfill power requirements and security constraints related to the use of such processing tools, as opposed to user equipment (UE) devices that may be limited in processing power and available battery power. This disclosure describes techniques that may be used to offer such processing tasks by intermediate network devices and how to integrate such processing tasks into a media communication session, such as an IMS call.

In some examples, the techniques of this disclosure may include split rendering of augmented reality (AR) media data or other extended reality (XR) media data, such as mixed reality (MR) or virtual reality (VR). A split rendering server may perform at least part of a rendering process to form rendered images, then stream the rendered images to a display device, such as AR glasses or a head mounted display (HMD). In general, a user may wear the display device, and the display device may capture pose information, such as a user position and orientation/rotation in real world space, which may be translated to render images for a viewport in a virtual world space.

Split rendering may enhance a user experience through providing access to advanced and sophisticated rendering that otherwise may not be possible or may place excess power and/or processing demands on AR glasses or a user equipment (UE) device. In split rendering all or parts of the 3D scene are rendered remotely on an edge application server, also referred to as a “split rendering server” in this disclosure. The results of the split rendering process are streamed down to the UE or AR glasses for display. The spectrum of split rendering operations may be wide, ranging from full pre-rendering on the edge to offloading partial, processing-extensive rendering operations to the edge.

The display device (e.g., UE/AR glasses) may stream pose predictions to the split rendering server at the edge. The display device may then receive rendered media for display from the split rendering server. The XR runtime may be configured to receive rendered data together with associated pose information (e.g., information indicating the predicted pose for which the rendered data was rendered) for proper composition and display. For instance, the XR runtime may need to perform pose correction to modify the rendered data according to an actual pose of the user at the display time. This disclosure describes techniques for conveying render pose information together with rendered images, e.g., in the form of a Real-time Transport Protocol (RTP) header extension. In this manner, the display device can accurately correct and display rendered images when the images were rendered by a separate device, e.g., for split rendering. This may allow advanced rendering techniques to be performed by the split rendering server while also presenting images that accurately reflect a user pose (e.g., position and orientation/rotation) to the user.

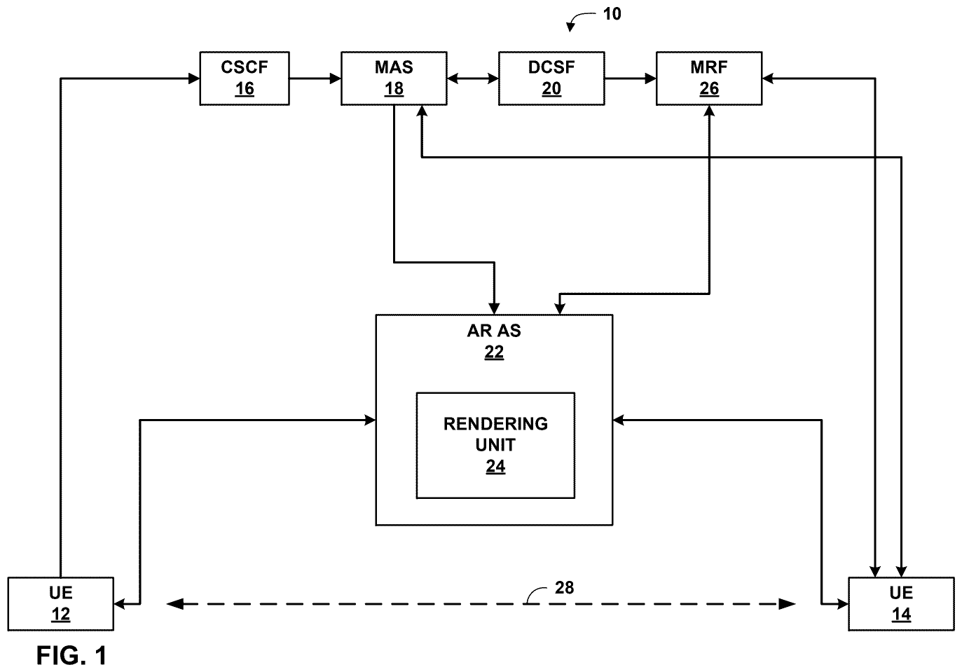

FIG. 1 is a block diagram illustrating an example network 10 including various devices for performing the techniques of this disclosure. In this example, network 10 includes user equipment (UE) devices 12, 14, call session control function (CSCF) 16, multimedia application server (MAS) 18, data channel signaling function (DCSF) 20, multimedia resource function (MRF) 26, and augmented reality application server (AR AS) 22. MAS 18 may correspond to a multimedia telephony application server, an IP Multimedia Subsystem (IMS) application server, or the like.

UEs 12, 14 represent examples of UEs that may participate in an AR communication session 28. AR communication session 28 may generally represent a communication session during which users of UEs 12, 14 exchange voice, video, and/or AR data (and/or other XR data). For example, AR communication session 28 may represent a conference call during which the users of UEs 12, 14 may be virtually present in a virtual conference room, which may include a virtual table, virtual chairs, a virtual screen or white board, or other such virtual objects. The users may be represented by avatars, which may be realistic or cartoonish depictions of the users in the virtual AR scene. The users may interact with virtual objects, which may cause the virtual objects to move or trigger other behaviors in the virtual scene. Furthermore, the users may navigate through the virtual scene, and a user's corresponding avatar may move according to the user's movements or movement inputs. In some examples, the users' avatars may include faces that are animated according to the facial movements of the users (e.g., to represent speech or emotions, e.g., smiling, thinking, frowning, or the like).

UEs 12, 14 may exchange AR media data related to a virtual scene, represented by a scene description. Users of UEs 12, 14 may view the virtual scene including virtual objects, as well as user AR data, such as avatars, shadows cast by the avatars, user virtual objects, user provided documents such as slides, images, videos, or the like, or other such data. Ultimately, users of UEs 12, 14 may experience an AR call from the perspective of their corresponding avatars (in first or third person) of virtual objects and avatars in the scene.

UEs 12, 14 may collect pose data for users of UEs 12, 14, respectively. For example, UEs 12, 14 may collect pose data including a position of the users, corresponding to positions within the virtual scene, as well as an orientation of a viewport, such as a direction in which the users are looking (i.e., an orientation of UEs 12, 14 in the real world, corresponding to virtual camera orientations). UEs 12, 14 may provide this pose data to AR AS 22 and/or to each other.

CSCF 16 may be a proxy CSCF (P-CSCF), an interrogating CSCF (I-CSCF), or serving CSCF (S-CSCF). CSCF 16 may generally authenticate users of UEs 12 and/or 14, inspect signaling for proper use, provide quality of service (QOS), provide policy enforcement, participate in session initiation protocol (SIP) communications, provide session control, direct messages to appropriate application server(s), provide routing services, or the like. CSCF 16 may represent one or more I/S/P CSCFs.

MAS 18 represents an application server for providing voice, video, and other telephony services over a network, such as a 5G network. MAS 18 may provide telephony applications and multimedia functions to UEs 12, 14.

DCSF 20 may act as an interface between MAS 18 and MRF 26, to request data channel resources from MRF 26 and to confirm that data channel resources have been allocated. DCSF 20 may receive event reports from MAS 18 and determine whether an AR communication service is permitted to be present during a communication session (e.g., an IMS communication session).

MRF 26 may be an enhanced MRF (eMRF) in some examples. In general, MRF 26 generates scene descriptions for each participant in an AR communication session. MRF 26 may support an AR conversational service, e.g., including providing transcoding for terminals with limited capabilities. MRF 26 may collect spatial and media descriptions from UEs 12, 14 and create scene descriptions for symmetrical AR call experiences. In some examples, rendering unit 24 may be included in MRF 26 instead of AR AS 22, such that MRF 26 may provide remote AR rendering services, as discussed in greater detail below.

MRF 26 may request data from UEs 12, 14 to create a symmetric experience for users of UEs 12, 14. The requested data may include, for example, a spatial description of a space around UEs 12, 14; media properties representing AR media that each of UEs 12, 14 will be sending to be incorporated into the scene; receiving media capabilities of UEs 12, 14 (e.g., decoding and rendering/hardware capabilities, such as a display resolution); and information based on detecting location, orientation, and capabilities of physical world devices that may be used in an audio-visual communication sessions. Based on this data, MRF 26 may create a scene that defines placement of each user and AR media in the scene (e.g., position, size, depth from the user, anchor type, and recommended resolution/quality); and specific rendering properties for AR media data (e.g., if 2D media should be rendered with a “billboarding” effect such that the 2D media is always facing the user). MRF 26 may send the scene data to each of UEs 12, 14 using a supported scene description format.

AR AS 22 may participate in AR communication session 28. For example, AR AS 22 may provide AR service control related to AR communication session 28. AR service control may include AR session media control and AR media capability negotiation between UEs 12, 14 and rendering unit 24.

AR AS 22 also includes rendering unit 24, in this example. Rendering unit 24 may perform split rendering on behalf of at least one of UEs 12, 14. In some examples, two different rendering units may be provided. In general, rendering unit 24 may perform a first set of rendering tasks for, e.g., UE 14, and UE 14 may complete the rendering process, which may include warping rendered viewport data to correspond to a current view of a user of UE 14. For example, UE 14 may send a predicted pose (position and orientation) of the user to rendering unit 24, and rendering unit 24 may render a viewport according to the predicted pose. However, if the actual pose is different than the predicted pose at the time video data is to be presented to a user of UE 14, UE 14 may warp the rendered data to represent the actual pose (e.g., if the user has suddenly changed movement direction or turned their head).

While only a single rendering unit is shown in the example of FIG. 1, in other examples, each of UEs 12, 14 may be associated with a corresponding rendering unit. Rendering unit 24 as shown in the example of FIG. 1 is included in AR AS 22, which may be an edge server at an edge of a communication network. However, in other examples, rendering unit 24 may be included in a local network of, e.g., UE 12 or UE 14. For example, rendering unit 24 may be included in a PC, laptop, tablet, or cellular phone of a user, and UE 14 may correspond to a wireless display device, e.g., AR/VR/MR/XR glasses or head mounted display (HMD). Although two UEs are shown in the example of FIG. 1, in general, multi-participant AR calls are also possible.

UEs 12, 14, and AR AS 22 may communicate AR data using a network communication protocol, such as Real-time Transport Protocol (RTP), which is standardized in Request for Comment (RFC) 3550 by the Internet Engineering Task Force (IETF). These and other devices involved in RTP communications may also implement protocols related to RTP, such as RTP Control Protocol (RTCP), Real-time Streaming Protocol (RTSP), Session Initiation Protocol (SIP), and/or Session Description Protocol (SDP).

In general, an RTP session may be established as follows. UE 12, for example, may receive an RTSP describe request from, e.g., UE 14. The RTSP describe request may include data indicating what types of data are supported by UE 14. UE 12 may respond to UE 14 with data indicating media streams that can be sent to UE 14, along with a corresponding network location identifier, such as a uniform resource locator (URL) or uniform resource name (URN).

UE 12 may then receive an RTSP setup request from UE 14. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on UE 14. UE 12 may reply to the RTSP setup request with a confirmation and data representing ports of UE 12 by which the RTP data and control data will be sent. UE 12 may then receive an RTSP play request, to cause the media stream to be “played,” i.e., sent to UE 14. UE 12 may also receive an RTSP teardown request to end the streaming session, in response to which, UE 12 may stop sending media data to UE 14 for the corresponding session.

UE 14, likewise, may initiate a media stream by initially sending an RTSP describe request to UE 12. The RTSP describe request may indicate types of data supported by UE 14. UE 14 may then receive a reply from UE 12 specifying available media streams, such as media content 64, that can be sent to UE 14, along with a corresponding network location identifier, such as a uniform resource locator (URL) or uniform resource name (URN).

UE 14 may then generate an RTSP setup request and send the RTSP setup request to UE 12. As noted above, the RTSP setup request may contain the network location identifier for the requested media data (e.g., media content 64) and a transport specifier, such as local ports for receiving RTP data and control data (e.g., RTCP data) on UE 14. In response, UE 14 may receive a confirmation from UE 12, including ports of UE 12 that UE 12 will use to send media data and control data.

After establishing a media streaming session (e.g., AR communication session 28) between UE 12 and UE 14, UE 12 exchange media data (e.g., packets of media data) with UE 14 according to the media streaming session. UE 12 and UE 14 may exchange control data (e.g., RTCP data) indicating, for example, reception statistics by UE 14, such that UEs 12, 14 can perform congestion control or otherwise diagnose and address transmission faults.

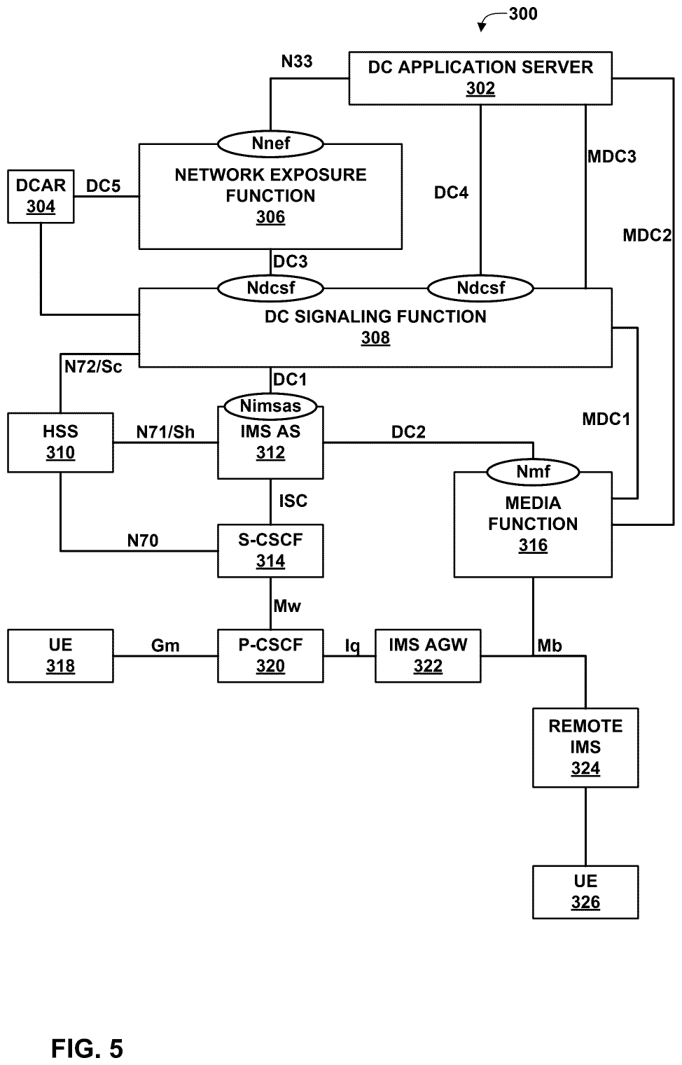

Per techniques of this disclosure, either or both of UEs 12, 14 may signal support for local and/or in-network media processing, e.g., by UE 12, UE 14, AR AS 22, or other devices (e.g., a media function (MF) device, as shown in greater detail in FIG. 5 and discussed below). UEs 12, 14 may signal support for such local and/or in-network media processing through the use of a feature tag in a Contact header field of a session initiation protocol (SIP) REGISTER message. The feature tag may have a value of, for example, “3gpp-media-processing.” Presence of the feature tag in the registration entry may indicate that the sending UE (e.g., the one of UEs 12, 14 that sent the REGISTER message) supports local and/or media processing by a network device, such as AR AS 22.

In some examples, AR AS 22 or another network device may offer in-network media processing as a web application over a data channel. That is, UEs 12, 14 may retrieve a web application associated with processing tasks to be performed by, e.g., AR AS 22, and execute the web application to send and receive media data of a media communication session to cause AR AS 22 to execute the processing tasks on the media data. One of UEs 12, 14 may establish a data channel to MRF 26 (or an MF) and request a list of available media processing tasks. For example, UE 12 may request the list of available media processing tasks from MRF 26, including sending an HTTP GET request over the data channel to MRF 26, where a URL of the HTTP GET request may correspond to a request for the list of available media processing tasks that AR AS 22 can perform on behalf of UE 12.

Such media processing tasks may include predefined processing tasks and/or artificial intelligence/machine learning (AI/ML)-based processing tasks. The AI/ML-based processing tasks may include one or more natural language processing (NLP) processing tasks. MRF 26 may indicate media processing tasks as a special category provided as part of a web application list. Alternatively, MRF 26 may indicate the media processing tasks using a well-known application identifier sent over an application data channel.

NLP processing tasks may be performed on audio data of a media communication session. For example, AR AS 22 may include one or more NLP processing units configured to perform automatic speech recognition (e.g., to automatically generate timed text/closed caption data presented along with video data of the media communication session), voice translation (e.g., to translate voice data from one language to another, in either or both of audio and/or closed caption data), voice commands, speech synthesis, or the like. For example, a user of UE 12 may speak a first language when sanding audio data of AR communication session 28 to UE 14. UE 14 may request translation of speech data in the first language to closed caption data in a second, different language. AR AS 22 may process audio data received from UE 12 to translate voice data expressed in the first language into closed caption data in the second language, and provide the translated closed caption/timed text data to UE 14 along with corresponding media segments (e.g., audio and video data of AR communication session 28).

AI/ML processing tasks may also, additionally or alternatively, be performed on video or image data of the media communication session. For example, AR AS 22 may be configured to apply image filters to images or frames of video data exchanged as part of a media communication session.

Any or all of the processing tasks may be associated with a respective list of requirements that need to be satisfied to activate the corresponding processing task. Such requirements may include any or all of: required media streams and their types, e.g., at least one video stream; directionality of processing, e.g., upstream, downstream, or bidirectional; supported media codecs for each stream (to ensure that the task does not modify the negotiated media codecs for the session); minimum number of participants to activate the task; a time window and geographical location where the task can be performed; and/or an associated cost of activating the processing task. UE 12 may, after receiving the processing task requirements from MRF 26, ensure that the requirements for each processing task to be requested are met. If so, UE 12 may send a message over the data channel to MRF 26 to activate the processing task.

Control and management messages may also be used as part of establishing and/or performing the processing tasks. Such control/management messages may be formatted according to JavaScript Object Notation (JSON) messages. The messages may include any or all of: an identification of the corresponding UE (e.g., one of UEs 12, 14); an identifier of the processing task; a requested operation (e.g., activate, deactivate, replace, modify); and/or a mapping of input stream identifiers to the session media stream identifiers. UE 14 (for example) may receive a confirmation of a successful operation from MRF 26 via the same data channel.

Some media processing tasks may require configuration. For example, for a real-time translation task, input and output languages may be selected by a user of, e.g., UE 12. To support such configuration, UE 12 may retrieve a task description from MRF 26 over the data channel. The description may include a reference to a web application that is used for user configuration. UE 12 may download the web application, render the web application to the user (e.g., as an overlay to a dialer application), then pass form parameters back to MRF 26. These parameters may then be used by MRF 26 to configure the task or update its configuration.

In some examples, the media processing task may be split between UE 12 and the network (e.g., AR AS 22). The task description in such a case may include a link to the part that is to be performed by, e.g., UE 12, as well as its input and output descriptions. This may be restricted to processing-intensive tasks, such as running a Deep Neural Network (DNN) model on the UE side.

In this manner, the techniques of this disclosure may allow for flexible deployment of various processing-intensive tasks, which may correspond to any of a growing set of media processing tasks in an IMS call based on user selections. These techniques may be deployed on top of existing IMS capabilities, such as the IMS data channel, or other media communication technologies. These techniques allow for dynamic activation and deactivation of one or more media processing tasks during a media communication session (call).

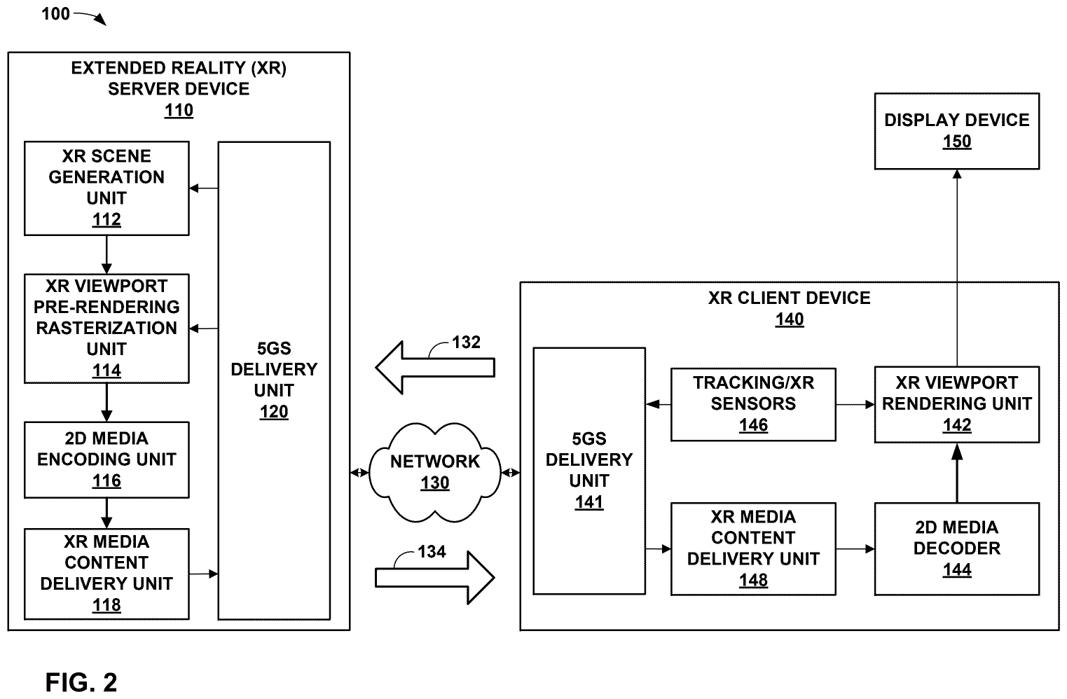

FIG. 2 is a block diagram illustrating an example computing system 100 that may perform split rendering techniques of this disclosure. In this example, computing system 100 includes extended reality (XR) server device 110, network 130, XR client device 140, and display device 150. XR server device 110 includes XR scene generation unit 112, XR viewport pre-rendering rasterization unit 114, 2D media encoding unit 116, XR media content delivery unit 118, and 5G System (5GS) delivery unit 120.

Network 130 may correspond to any network of computing devices that communicate according to one or more network protocols, such as the Internet. In particular, network 130 may include a 5G radio access network (RAN) including an access device to which XR client device 140 connects to access network 130 and XR server device 110. In other examples, other types of networks, such as other types of RANs, may be used. For example, network 130 may represent a wireless or wired local network. In other examples, XR client device 140 and XR server device 110 may communicate via other mechanisms, such as Bluetooth, a wired universal serial bus (USB) connection, or the like. XR client device 140 includes 5GS delivery unit 141, tracking/XR sensors 146, XR viewport rendering unit 142, 2D media decoder 144, and XR media content delivery unit 148. XR client device 140 also interfaces with display device 150 to present XR media data to a user (not shown).

In some examples, XR scene generation unit 112 may correspond to an interactive media entertainment application, such as a video game, which may be executed by one or more processors implemented in circuitry of XR server device 110. XR viewport pre-rendering rasterization unit 114 may format scene data generated by XR scene generation unit 112 as pre-rendered two-dimensional (2D) media data (e.g., video data) for a viewport of a user of XR client device 140. 2D media encoding unit 116 may encode formatted scene data from XR viewport pre-rendering rasterization unit 114, e.g., using a video encoding standard, such as ITU-T H.264/Advanced Video Coding (AVC), ITU-T H.265/High Efficiency Video Coding (HEVC), ITU-T H.266 Versatile Video Coding (VVC), or the like. XR media content delivery unit 118 represents a content delivery sender, in this example. In this example, XR media content delivery unit 148 represents a content delivery receiver, and 2D media decoder 144 may perform error handling.

In general, XR client device 140 may determine a user's viewport, e.g., a direction in which a user is looking and a physical location of the user, which may correspond to an orientation of XR client device 140 and a geographic position of XR client device 140. Tracking/XR sensors 146 may determine such location and orientation data, e.g., using cameras, accelerometers, magnetometers, gyroscopes, or the like. Tracking/XR sensors 146 provide location and orientation data to XR viewport rendering unit 142 and 5GS delivery unit 141. XR client device 140 provides tracking and sensor information 132 to XR server device 110 via network 130. XR server device 110, in turn, receives tracking and sensor information 132 and provides this information to XR scene generation unit 112 and XR viewport pre-rendering rasterization unit 114. In this manner, XR scene generation unit 112 can generate scene data for the user's viewport and location, and then pre-render 2D media data for the user's viewport using XR viewport pre-rendering rasterization unit 114. XR server device 110 may therefore deliver encoded, pre-rendered 2D media data 134 to XR client device 140 via network 130, e.g., using a 5G radio configuration.

XR scene generation unit 112 may receive data representing a type of multimedia application (e.g., a type of video game), a state of the application, multiple user actions, or the like. XR viewport pre-rendering rasterization unit 114 may format a rasterized video signal. 2D media encoding unit 116 may be configured with a particular ‘er/decoder (codec), bitrate for media encoding, a rate control algorithm and corresponding parameters, data for forming slices of pictures of the video data, low latency encoding parameters, error resilience parameters, intra-prediction parameters, or the like. XR media content delivery unit 118 may be configured with real-time transport protocol (RTP) parameters, rate control parameters, error resilience information, and the like. XR media content delivery unit 148 may be configured with feedback parameters, error concealment algorithms and parameters, post correction algorithms and parameters, and the like.

Raster-based split rendering refers to the case where XR server device 110 runs an XR engine (e.g., XR scene generation unit 112) to generate an XR scene based on information coming from an XR device, e.g., XR client device 140 and tracking and sensor information 132. XR server device 110 may rasterize an XR viewport and perform XR pre-rendering using XR viewport pre-rendering rasterization unit 114.

In the example of FIG. 2, the viewport is predominantly rendered in XR server device 110, but XR client device 140 is able to do latest pose correction, for example, using asynchronous time-warping or other XR pose correction to address changes in the pose. XR graphics workload may be split into rendering workload on a powerful XR server device 110 (in the cloud or the edge) and pose correction (such as asynchronous timewarp (ATW)) on XR client device 140. Low motion-to-photon latency is preserved via on-device Asynchronous Time Warping (ATW) or other pose correction methods performed by XR client device 140.

The various components of XR server device 110, XR client device 140, and display device 150 may be implemented using one or more processors implemented in circuitry, such as one or more digital signal processors (DSPs), general purpose microprocessors, application specific integrated circuits (ASICs), field programmable logic arrays (FPGAs), or other equivalent integrated or discrete logic circuitry. The functions attributed to these various components may be implemented in hardware, software, or firmware. When implemented in software or firmware, it should be understood that instructions for the software or firmware may be stored on a computer-readable medium and executed by requisite hardware.

XR client device 140 may be configured to perform techniques of this disclosure. For example, XR client device 140 may request that XR server device 110 (or another device not shown in FIG. 2) perform one or more media processing tasks on media data to be sent to or received by XR client device 140, as discussed herein.

In this manner, XR client device 140 represents an example of a first user equipment (UE) device for communicating media data that includes: a memory configured to store media data; and a processing system implemented in circuitry and configured to: establish a media communication session with a second UE device; request that an intermediate network device perform one or more media processing tasks on media data destined for the second UE device and originating from the first UE device, the intermediate network device being between the first UE device and the second UE device; and send the media data of the media communication session destined for the second UE device to the intermediate network device to cause the intermediate network device to perform the one or more media processing tasks on the media data.

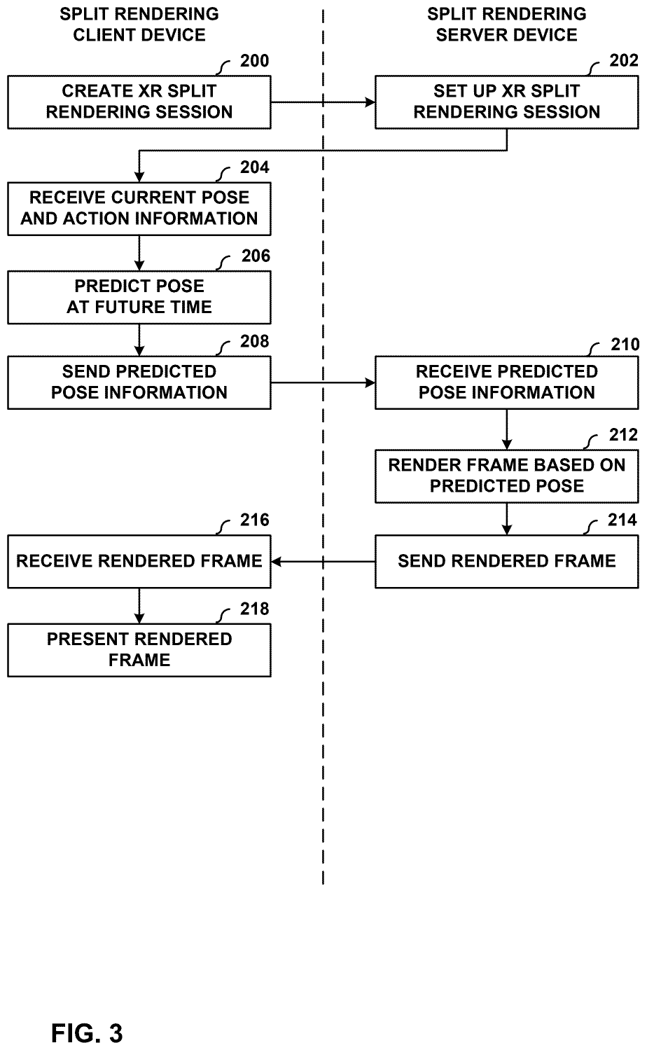

FIG. 3 is a flowchart illustrating an example method of performing split rendering according to techniques of this disclosure. The method of FIG. 3 may be performed by a split rendering client device, such as XR client device 140 of FIG. 2, in conjunction with a split rendering server device, such as XR server device 110 of FIG. 2.

Initially, the split rendering client device creates an XR split rendering session (200). As discussed above, creating the XR split rendering session may include, for example, sending device information and capabilities, such as supported decoders, viewport information (e.g., resolution, size, etc.), or the like. The split rendering server device sets up an XR split rendering session (202), which may include setting up encoders corresponding to the decoders and renderers corresponding to the viewport supported by the split rendering client device.

The split rendering client device may then receive current pose and action information (204). For example, the split rendering client device may collect XR pose and movement information from tracking/XR sensors (e.g., tracking/XR sensors 146 of FIG. 2). The split rendering client device may then predict a user pose (e.g., position and orientation) at a future time (206). The split rendering client device may predict the user pose according to a current position and orientation, velocity, and/or angular velocity of the user/a head mounted display (HMD) worn by the user. The predicted pose may include a position in an XR scene, which may be represented as an {X, Y, Z} triplet value, and an orientation/rotation, which may be represented as an {RX, RY, RZ, RW} quaternion value. The split rendering client device may send the predicted pose information, (optionally) along with any actions performed by the user to the split rendering server device (208).

The split rendering server device may receive the predicted pose information (210) from the split rendering client device. The split rendering server device may then render a frame for the future time based on the predicted pose at that future time (212). For example, the split rendering server device may execute a game engine that uses the predicted pose at the future time to render an image for the corresponding viewport, e.g., based on positions of virtual objects in the XR scene relative to the position and orientation of the user's pose at the future time. The split rendering server device may then send the rendered frame to the split rendering client device (214).

The split rendering client device may then receive the rendered frame (216) and present the rendered frame at the future time (218). For example, the split rendering client device may receive a stream of rendered frames and store the received rendered frames to a frame buffer. At a current display time, the split rendering client device may determine the current display time and then retrieve one of the rendered frames from the buffer having a presentation time that is closest to the current display time.

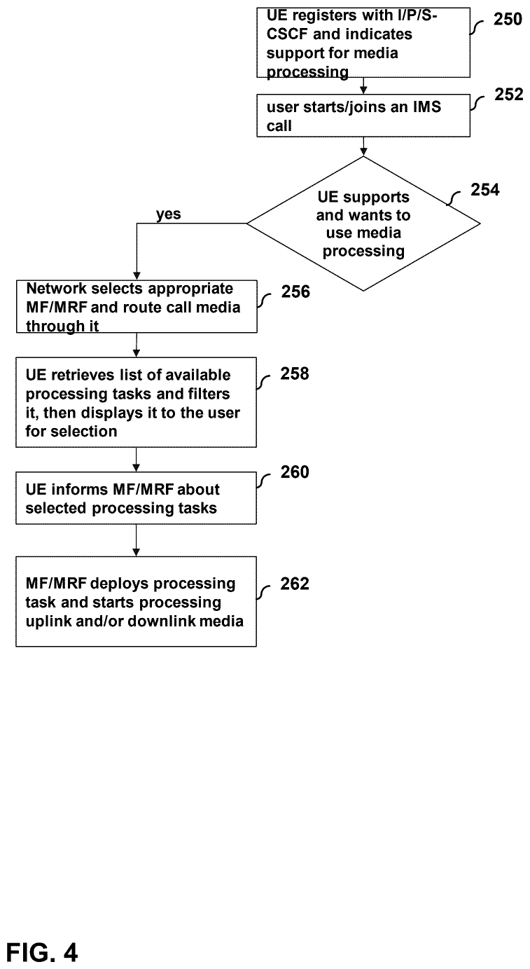

FIG. 4 is a flowchart illustrating an example method of communicating media data according to the techniques of this disclosure. The method of FIG. 4 may be performed by a user equipment (UE), such as one of UEs 12, 14 of FIG. 1. For purposes of example and explanation, the method of FIG. 4 is explained with respect to UE 14, as well as CSCF 16 and MRF 26, of FIG. 1.

Initially, UE 14 registers with an I/P/S-CSCF (such as CSCF 16 of FIG. 1) and indicates support for media processing (250). As explained above, such support indication may be a “3gpp-media-processing” value for a feature tag in a Contact header of a SIP REGISTER message sent by UE 14 to CSCF 16. A user of UE 14 may also start or join an IMS call (252). It is assumed in this example that UE 14 indicates support for and the user's desire for media processing tasks (254). CSCF 16 or another network device may select an appropriate MF/MRF (e.g., MRF 26 in FIG. 1) and route call media through the selected MF/MFR (256).

UE 14 may then retrieve a list of available processing tasks for the call, as well as any requirements to enable the processing tasks. UE 14 may filter the available processing tasks based on media communication session configuration data and capabilities of UE 14. For each of the processing tasks, a user of UE 14 and/or UE 14 itself may determine whether the requirements are satisfied, and UE 14 may present the list of available and supported processing tasks to the user (258). The user may determine which of the tasks is to be enabled, e.g., via a user interface of UE 14. UE 14 may then provide data to, e.g., MRF 26 indicative of which of the processing tasks has been selected (260). MRF 26 may then deploy the processing tasks (e.g., to AR AS 22) and start processing uplink and/or downlink media (262) according to the processing tasks.

In this manner, the method of FIG. 4 represents an example of a method of communicating media data, including: establishing, by a first user equipment (UE) device, a media communication session with a second UE device; requesting, by the first UE device, that an intermediate network device perform one or more media processing tasks on media data destined for the second UE device and originating from the first UE device, the intermediate network device being between the first UE device and the second UE device; and sending, by the first UE device, the media data of the media communication session destined for the second UE device to the intermediate network device to cause the intermediate network device to perform the one or more media processing tasks on the media data.

FIG. 5 is a block diagram illustrating an example architecture 300 that may be used to support IP Multimedia Subsystem (IMS) data channels per techniques of this disclosure. In this example, FIG. 5 depicts data channel (DC) application server 302, DC application repository 304, network exposure function 306, DC signaling function 308, home subscriber server (HSS) 310, IP multimedia subsystem (IMS) application server (AS) 312, serving-call session control function (S-CSCF) 314, user equipment (UE) 318, proxy-CSCF (P-CSCF) 320, IMS access gateway (IMS AGW) 322, remote IMS 324, and UE 326. Various elements of FIG. 5 may correspond to elements of FIG. 1. For example, UE 318 of FIG. 5 may correspond to UE 12 of FIG. 1; UE 326 of FIG. 5 may correspond to UE 14 of FIG. 1; MF 316 may correspond to MRF 26 and/or AR AS 22 of FIG. 1; DCSF 308 of FIG. 5 may correspond to DSCF 20 of FIG. 1; P-CSCF 320 of FIG. 5 may correspond to CSCF 16 of FIG. 1; and IMS AS 312 of FIG. 5 may correspond to MAS 18 of FIG. 1.

IMS data channels may support the enhancement of multimedia telephony with advanced application logic through web applications. UE 318 may establish a bootstrap data channel with media function (MF) 316 as part of a multimedia telephony session, then UE 318 may retrieve (download) a list of available web applications. UE 318 may then offer the web applications to a user of UE 318. Once a user has made a selection of a web application, UE 318 may download the selected web application locally. The local UE may then inform remote UE 326, through a re-INVITE, about the selected web application, so that both endpoints (e.g., both of UEs 318, 326) are using the same web application. UEs 318, 326 may then establish an application data channel between endpoints to exchange application specific data (e.g., media data). UE 318 may use the HTTP protocol for communication over the bootstrap channel.

DC Application Server 302 may act as the endpoint for application data channels. DC Application Server 302 may communicate with data channel signaling function (DCSF) 308 for resource control and traffic forwarding and also to support interaction with multiple UEs 318, 326 for simultaneous data channel applications.

DCSF 308 may manage the signaling control for data channels. DCSF 308 may implement data channel control and manage resources for both bootstrap and application data channels. DCSF 308 may also manage the download and configuration of data channel applications from data channel application repository (DCAR) 304. For example, DCSF 308 may send web applications stored by DCAR 304 to UEs 318, 326.

Media Function (MF) 316 (or an MRF) may manage media resources and forward data channel traffic. MF 316 may terminate the bootstrap data channel from UE 318 and forward HTTP traffic to DCSF 308. MF 316 may provide the media resources to anchor application data channels and relay traffic between UEs 318, 326. MF 316 may terminate the application data channel by acting as an HTTP proxy or simply relay traffic by acting as a UDP proxy.

Data Channel Application Repository (DCAR) 304 stores and manages verified data channel applications. UEs 318, 326 may download the data channel applications (e.g., web applications) through DCSF 308 and MF 316.

IMS application server (AS) 312 may support data channel functionalities and manage interactions between the different entities of architecture 300.

In this manner, UE 318 represents an example of a first user equipment (UE) device for communicating media data, including: a memory configured to store media data; and a processing system implemented in circuitry and configured to: establish a media communication session with a second UE device; request that an intermediate network device perform one or more media processing tasks on media data destined for the second UE device and originating from the first UE device, the intermediate network device being between the first UE device and the second UE device; and send the media data of the media communication session destined for the second UE device to the intermediate network device to cause the intermediate network device to perform the one or more media processing tasks on the media data.

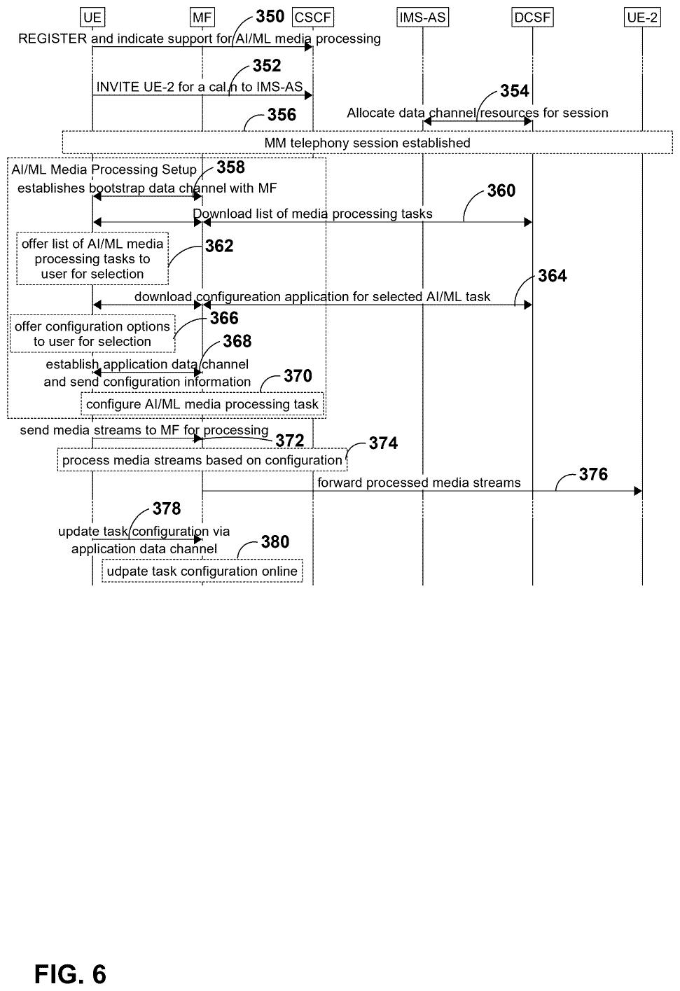

FIG. 6 is a flow diagram illustrating an example method for mapping various media processing tasks to devices of an IMS per techniques of this disclosure. The processing tasks may include artificial intelligence and/or machine learning (AI/ML) processing tasks. The techniques of this disclosure may support various use cases, such as natural language processing (NLP) use cases. NLP may correspond to any of a wide range of media processing tasks that can be applied to a multimedia call. To support these use cases, it should be possible to integrate the media processing with the media of a multimedia telephony service over IMS (MTSI) call. This is best done by leveraging the existing data channel infrastructure, where AI/ML media processing is treated as a special category of web applications.

The supported media processing may be discovered as part of the data channel application discovery process over the bootstrap channel. The AI/ML media processing itself may be run in the UE, MF, or on both (split processing). FIG. 6 depicts an example process to trigger AI/ML media processing.

As shown in FIG. 6, launching and applying AI/ML media processing tasks on the media streams of a call may be realized through the usage of data channels. A bootstrap data channel may be used to discover available AI/ML media processing tasks. The application data channel may then be established to select, configure, and manage the AI/ML media processing tasks. A split inference may be configured by using the downloaded API and applying web technologies, such as WebCodes and WebNN, on the UE side to do the UE inference.

The call flow of FIG. 6 is explained with respect to the devices shown in FIG. 5. However, the devices of FIG. 1 or other sets of devices may be configured to perform this or a similar method. Initially, UE 318 sends a registration message including data representing support for AI/ML media processing to P-CSCF 320 (350). The registration message may be, for example, a SIP REGISTER message. The registration message may include a Contact header field, and UE 318 may indicate support for AI/ML media processing (locally and/or in-network) by including a feature tag having a value of, e.g., “3gpp-media-processing,” in the Contact header field.

UE 318 may then send an invite to UE 326 to participate in a media communication session (352). The invite may be a SIP INVITE message.

IMS AS 312 and DCSF 308 may then allocate data channel resources for the media communication session (354).

UE 318 and UE 326 may then establish a multimedia telephony session for the media communication session (356). That is, after sending the invite, UE 326 may send, and UE 318 may receive, an acknowledgement of the invite in order to establish the media communication session.

UE 318 may then establish a bootstrap data channel with MF 316 (358). UE 318 may send an HTTP GET request to MF 316 to retrieve a list of available media processing tasks (360). MF 316 may further request the list of available media processing tasks from DCSF 308 and respond to the HTTP GET request with data representing the list of available media processing tasks. The media processing tasks may be associated with respective web applications.

UE 318 may then offer the list of available media processing tasks (which may include AI/ML processing tasks) to a user of UE 318 for selection by the user (362). For example, UE 318 may present a selection screen indicating the list of available media processing tasks via a user interface (e.g., a touchscreen) of UE 318. In response to receiving a selection of the media processing tasks from the user, UE 318 may download a configuration application for the selected media processing tasks (364). For example, UE 318 may retrieve a web application associated with the selected media processing tasks (e.g., AI/ML processing tasks, such as NPL processing tasks) over the bootstrap channel from DCSF 308 via MF 316.

UE 318 may then offer configuration options to the user for selection (366). For example, UE 318 may execute the retrieved web application and render user interface data of the web application via the user interface (e.g., touchscreen) of UE 318. UE 318 may then receive user input for the configuration options from the user (e.g., via the touchscreen). UE 318 may then establish an application data channel with MF 316 and send configuration information received from the user to MF 316 via the application data channel (368). MF 316 may then use the data received from UE 318 via the application data channel to configure the media processing tasks (e.g., AI/ML processing tasks) accordingly (370).

UE 318 may then send media data (e.g., audio, image, video, and/or augmented reality (AR) data) to MF 316 for processing (372). MF 316 may perform the selected processing tasks on the media data received from UE 318 (374) and forward the processed media data to UE 326 (376).

In some examples, during the media communication session, the processing tasks to be performed may be updated. Thus, as shown in FIG. 6, UE 318 may send an updated task configuration to MF 316 via the application data channel (378). MF 316 may update the task configuration to reflect the new set of media processing tasks/configuration for media processing tasks for subsequent media data (380).

In this manner, the method of FIG. 6 represents an example of a method of communicating media data, including: establishing, by a first user equipment (UE) device, a media communication session with a second UE device; requesting, by the first UE device, that an intermediate network device perform one or more media processing tasks on media data destined for the second UE device and originating from the first UE device, the intermediate network device being between the first UE device and the second UE device; and sending, by the first UE device, the media data of the media communication session destined for the second UE device to the intermediate network device to cause the intermediate network device to perform the one or more media processing tasks on the media data.

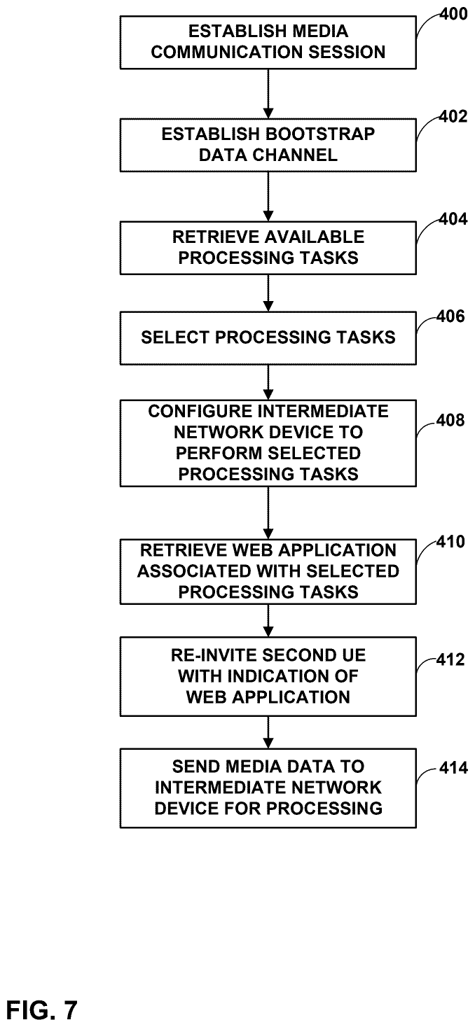

FIG. 7 is a flowchart illustrating an example method of enabling media processing tasks for media data of a media communication session according to techniques of this disclosure. The method of FIG. 7 is explained with respect to UE 318 of FIG. 5, although this or a similar method may be performed by other devices, such as UEs 12, 14 of FIG. 1, XR client device 140 of FIG. 2, or UE 326 of FIG. 5.

Initially, UE 318 establishes a media communication session (400) with another UE, e.g., UE 326 of FIG. 5. For example, UE 318 may send a SIP INVITE message to UE 326. As part of establishing the media communication session, UE 318 may also register support for media processing tasks, such as local and/or network AI/ML (e.g., NLP) processing tasks. For example, UE 318 may send a SIP REGISTER message indicating whether the media processing tasks can be performed locally or whether UE 318 requires partial or full network processing for the media processing tasks. It is assumed in this example that UE 318 requests network processing to perform the media processing tasks.

UE 318 may thus establish a bootstrap data channel with MF 316 of FIG. 5 (402). MF 316 represents an example of an intermediate network device positioned between UE 318 and UE 326 that may perform the media processing tasks. Other examples of such an intermediate network device include AR AS 22, MRF 26, and XR server device 110. UE 318 may retrieve a list of available media processing tasks from MF 316 (404). For example, UE 318 may issue an HTTP GET request to a URL associated with the list of available media processing tasks, which may cause MF 316 to retrieve the list of available media processing tasks from DCSF 308 and send the list of available media processing tasks to UE 318.

UE 318 may then select one or more of the available media processing tasks to be performed by MF 316 (406). For example, UE 318 may present the list of available media processing tasks to a user of UE 318, and receive a user selection of media processing tasks to be performed. UE 318 may then configure the intermediate network device (i.e., MF 316, in this example) to perform the selected media processing tasks (408). UE 318 may also retrieve a web application from MF 316 associated with the selected processing tasks. MF 316 may retrieve data for the web application from DCAR 304 and send the data for the web application to UE 318.

UE 318 may re-invite UE 326 to the media communication session by sending, e.g., a SIP Re-INVITE message including data representative of the web application (410). This may cause UE 326 to retrieve the web application as well, such that both UE 318 and UE 326 execute the same web application for the media communication session.

Ultimately, UE 318 may send media data of the media communication session destined for UE 326 to MF 316 to cause MF 316 to perform the selected media processing tasks on the media data (414). Thus, MF 316 may perform the selected media processing tasks on the media data and send the media data to UE 326. Likewise, MF 316 may also receive media data from UE 326 destined for UE 318. In some examples, MF 316 may perform the same, similar, or a different set of media processing tasks on data received from UE 326 that is destined for UE 318. For example, MF 316 may translate audio data of a first language from UE 318 into closed caption data of a second language, and translate audio data of the second language from UE 326 into closed caption data of the first language.

In this manner, the method of FIG. 7 represents an example of a method of communicating media data, including: establishing, by a first user equipment (UE) device, a media communication session with a second UE device; requesting, by the first UE device, that an intermediate network device perform one or more media processing tasks on media data destined for the second UE device and originating from the first UE device, the intermediate network device being between the first UE device and the second UE device; and sending, by the first UE device, the media data of the media communication session destined for the second UE device to the intermediate network device to cause the intermediate network device to perform the one or more media processing tasks on the media data.

Various examples of the techniques of this disclosure are summarized in the following clauses:

Clause 1: A method of communicating media data, the method comprising: requesting, by a first user equipment (UE) device engaged in a media communication session with a second UE device, that an intermediate network device perform one or more media processing tasks on media data exchanged between the first UE device and the second UE device, the intermediate network device being between the first UE device and the second UE device.

Clause 2: The method of clause 1, further comprising receiving processed media data that has been processed by the intermediate network device.

Clause 3: The method of any of clauses 1 and 2, further comprising sending media data to the intermediate network device to cause the network device to process the media data and send resulting processed media data to the second UE device.

Clause 4: The method of any of clauses 1-3, wherein the one or more processing tasks include one or more of applying a visual filter to an image or video data of the media data, applying a translation service to audio data of the media data, generating translated audio data for the media data, or generating translated timed text data from audio data of the media data.

Clause 5: The method of any of clauses 1-4, further comprising sending, by the first UE device, data indicating support for the media processing tasks being performed by the intermediate network device.

Clause 6: The method of clause 5, wherein the data indicating the support for the media processing tasks comprises a feature tag in a Contact header field of a session initiation protocol (SIP) REGISTER message.

Clause 7: The method of clause 6, wherein the feature tag has a value of “3gpp-media-processing.”

Clause 8: The method of any of clauses 1-7, further comprising receiving, by the first UE device, a list of available media processing tasks that can be performed by one or more intermediate network devices.

Clause 9: The method of clause 8, further comprising receiving one or more requirements for each of the available media processing tasks.

Clause 10: The method of clause 9, further comprising: determining, by the first UE device, a subset of the available media processing tasks that satisfy the corresponding requirements; and presenting, by the first UE device, the subset of the available media processing tasks to a user of the first UE device.

Clause 11: The method of any of clauses 9 and 10, wherein the one or more requirements include one or more of: required media streams and types for the media streams; directionality of processing on the media streams; supported media codecs for each of the media streams; a minimum number of participants in the media communication session; a time window and geographical location where the corresponding processing task can be used; or an associated cost to activate the corresponding processing task.

Clause 12: The method of any of clauses 8-11, further comprising receiving data from a user of the first UE device indicating one or more of the available media processing tasks to be enabled.

Clause 13: The method of any of clauses 1-12, further comprising sending a control or management message associated with at least one of the one or more media processing tasks.

Clause 14: The method of clause 13, wherein the control or management message comprises a JavaScript Object Notation (JSON) message.

Clause 15: The method of any of clauses 13 and 14, wherein the control or management message includes one or more of: an identifier of the first UE device; an identifier of a corresponding media processing task of the one or more media processing tasks; and a requested operation.

Clause 16: The method of clause 15, wherein the control or management message further includes a mapping of an input stream identifier to a session media stream identifier.

Clause 17: The method of any of clauses 1-16, further comprising retrieving a task description for at least one of the one or more media processing tasks, the task description including one or more parameters for configuring the at least one of the one or more media processing tasks.

Clause 18: The method of clause 17, further comprising sending values for each of the one or more parameters for configuring the at least one of the one or more media processing tasks to the intermediate network device.

Clause 19: The method of any of clauses 1-18, wherein at least one of the one or more media processing tasks comprises a split rendering processing task, the method further comprising receiving data representing one or more processes to be performed by the first UE device for the split rendering processing task.

Clause 20: A method of communicating media data, the method comprising: establishing, by a first user equipment (UE) device, a media communication session with a second UE device; establishing, by the first UE device, a bootstrap data channel with a media function (MF) device; receiving, by the first UE device and via the bootstrap data channel, a list of available media processing tasks that can be performed on media data of the media communication session; retrieving, by the first UE device, a web application associated with one or more media processing tasks of the list of available media processing tasks to be performed on the media data of the media communication session; executing, by the first UE device, the web application to cause the one or more media processing tasks to be performed on the media data of the media communication session; and exchanging, by the first UE device and through execution of the web application, the media data of the media communication session with the second UE device.

Clause 21: The method of clause 20, wherein at least one of the one or more media processing tasks comprises an artificial intelligence/machine learning (AI/ML) processing task, and wherein the web application is associated with the AI/ML processing task.

Clause 22: The method of clause 21, further comprising sending a session initiation protocol (SIP) register message including data representative of support the first UE device has for performing the AI/ML processing task to a call session control function (CSCF) device.

Clause 23: The method of clause 20, wherein the list of available media processing tasks includes one or more of applying a visual filter to an image or video data of the media data, applying a translation service to audio data of the media data, generating translated audio data for the media data, or generating translated timed text data from audio data of the media data.

Clause 24: The method of clause 20, wherein executing the web application comprises executing the web application to perform at least part of the one or more of the media processing tasks.

Clause 25: The method of clause 20, wherein executing the web application comprises executing the web application to send the media data to an intermediate network device to cause the intermediate network device to perform at least part of the one or more of the media processing tasks, the intermediate network device being between the first UE device and the second UE device.

Clause 26: The method of clause 20, wherein each of the available media processing tasks is associated with a respective set of one or more requirements to be satisfied in order to enable the corresponding media processing task, wherein each set of one or more requirements includes one or more of required media streams and types for the media streams, directionality of processing on the media streams, supported media codecs for each of the media streams, a minimum number of participants in the media communication session, a time window and geographical location where the corresponding processing task can be used, or an associated cost to activate the corresponding processing task.

Clause 27: The method of clause 20, further comprising sending a re-invite message to the second UE device to cause the second UE device to retrieve the web application for use during the media communication session.

Clause 28: A device for communicating media data, the device comprising one or more means for performing the method of any of clauses 1-27.

Clause 29: The device of clause 28, wherein the one or more means comprise a processing system comprising one or more processors implemented in circuitry, and a memory configured to store media data.

Clause 30: A first user equipment (UE) device for engaging in a media communication session with a second UE device, the first UE device comprising: means for requesting that an intermediate network device perform one or more media processing tasks on media data exchanged between the first UE device and the second UE device, the intermediate network device being between the first UE device and the second UE device.

Clause 31: A method of communicating media data, the method comprising: establishing, by a first user equipment (UE) device, a media communication session with a second UE device; requesting, by the first UE device, that an intermediate network device perform one or more media processing tasks on media data destined for the second UE device and originating from the first UE device, the intermediate network device being between the first UE device and the second UE device; and sending, by the first UE device, the media data of the media communication session destined for the second UE device to the intermediate network device to cause the intermediate network device to perform the one or more media processing tasks on the media data.

Clause 32: The method of clause 31, further comprising receiving media data from the intermediate network device that originated from the second UE device and that was processed by the intermediate network device according to the one or more media processing tasks.

Clause 33: The method of clause 31, wherein the one or more processing tasks include one or more of applying a visual filter to an image or video data of the media data, applying a translation service to audio data of the media data, generating translated audio data for the media data, or generating translated timed text data from audio data of the media data.

Clause 34: The method of clause 31, further comprising sending, by the first UE device, data indicating support for the media processing tasks being performed by the intermediate network device.

Clause 35: The method of clause 34, wherein the data indicating the support for the media processing tasks comprises a feature tag in a Contact header field of a session initiation protocol (SIP) REGISTER message.

Clause 36: The method of clause 35, wherein the feature tag has a value of “3gpp-media-processing.”

Clause 37: The method of clause 31, further comprising receiving, by the first UE device, a list of available media processing tasks that can be performed by one or more intermediate network devices.

Clause 38: The method of clause 37, further comprising receiving one or more requirements for each of the available media processing tasks.

Clause 39: The method of clause 38, further comprising: determining, by the first UE device, a subset of the available media processing tasks that satisfy the corresponding requirements; and presenting, by the first UE device, the subset of the available media processing tasks to a user of the first UE device.

Clause 40: The method of clause 38, wherein the one or more requirements include one or more of: required media streams and types for the media streams; directionality of processing on the media streams; supported media codecs for each of the media streams; a minimum number of participants in the media communication session; a time window and geographical location where the corresponding processing task can be used; or an associated cost to activate the corresponding processing task.

Clause 41: The method of clause 37, further comprising receiving data from a user of the first UE device indicating one or more of the available media processing tasks to be enabled.

Clause 42: The method of clause 31, further comprising sending a control or management message associated with at least one of the one or more media processing tasks.

Clause 43: The method of clause 42, wherein the control or management message comprises a JavaScript Object Notation (JSON) message.

Clause 44: The method of clause 42, wherein the control or management message includes one or more of: an identifier of the first UE device; an identifier of a corresponding media processing task of the one or more media processing tasks; or a requested operation.

Clause 45: The method of clause 44, wherein the control or management message further includes a mapping of an input stream identifier to a session media stream identifier.

Clause 46: The method of clause 31, further comprising retrieving a task description for at least one of the one or more media processing tasks, the task description including one or more parameters for configuring the at least one of the one or more media processing tasks.

Clause 47: The method of clause 46, further comprising sending values for each of the one or more parameters for configuring the at least one of the one or more media processing tasks to the intermediate network device.

Clause 48: The method of clause 31, wherein at least one of the one or more media processing tasks comprises a split rendering processing task, the method further comprising receiving data representing one or more processes to be performed by the first UE device for the split rendering processing task.

Clause 49: A first user equipment (UE) device for communicating media data, the first UE device comprising: a memory configured to store media data; and a processing system implemented in circuitry and configured to: establish a media communication session with a second UE device; request that an intermediate network device perform one or more media processing tasks on media data destined for the second UE device and originating from the first UE device, the intermediate network device being between the first UE device and the second UE device; and send the media data of the media communication session destined for the second UE device to the intermediate network device to cause the intermediate network device to perform the one or more media processing tasks on the media data.

Clause 50: A first user equipment (UE) device for communicating media data, the first UE device comprising: means for establishing a media communication session with a second UE device; means for requesting that an intermediate network device perform one or more media processing tasks on media data destined for the second UE device and originating from the first UE device, the intermediate network device being between the first UE device and the second UE device; and means for sending the media data of the media communication session destined for the second UE device to the intermediate network device to cause the intermediate network device to perform the one or more media processing tasks on the media data.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of communicating media data, the method comprising:
establishing, by a first user equipment (UE) device, a media communication session with a second UE device;
executing, by the first UE device, a web application to configure an intermediate network device to perform one or more media processing tasks on media data destined for the second UE device and originating from the first UE device, the intermediate network device being between the first UE device and the second UE device; and
sending, by the first UE device, the media data of the media communication session destined for the second UE device to the intermediate network device to cause the intermediate network device to perform the one or more media processing tasks on the media data.

2. The method of claim 1, further comprising receiving media data from the intermediate network device that originated from the second UE device and that was processed by the intermediate network device according to the one or more media processing tasks.

3. The method of claim 1, further comprising downloading the web application.

4. The method of claim 1, further comprising sending, by the first UE device, data indicating support for the media processing tasks being performed by the intermediate network device.

5. The method of claim 4, wherein the data indicating the support for the media processing tasks comprises a feature tag in a Contact header field of a session initiation protocol (SIP) REGISTER message.

6. The method of claim 5, wherein the feature tag has a value of “3gpp-media-processing.”

7. The method of claim 1, further comprising receiving, by the first UE device, a list of available media processing tasks that can be performed by one or more intermediate network devices.

8. The method of claim 7, further comprising receiving one or more requirements for each of the available media processing tasks.

9. The method of claim 8, further comprising:
determining, by the first UE device, a subset of the available media processing tasks that satisfy the requirements; and
presenting, by the first UE device, the subset of the available media processing tasks to a user of the first UE device.

10. The method of claim 8, wherein the one or more requirements include one or more of:
required media streams and types for the media streams;
directionality of processing on the media streams;
supported media codecs for each of the media streams;
a minimum number of participants in the media communication session;
a time window and geographical location where the corresponding media processing task can be used; or
an associated cost to activate the corresponding processing task.

11. The method of claim 7, further comprising receiving data from a user of the first UE device indicating one or more of the available media processing tasks to be enabled.

12. The method of claim 1, further comprising sending a control or management message associated with at least one of the one or more media processing tasks.

13. The method of claim 12, wherein the control or management message comprises a JavaScript Object Notation (JSON) message.

14. The method of claim 12, wherein the control or management message includes one or more of:
an identifier of the first UE device;
an identifier of a corresponding media processing task of the one or more media processing tasks; or
a requested operation.

15. The method of claim 14, wherein the control or management message further includes a mapping of an input stream identifier to a session media stream identifier.

16. The method of claim 1, further comprising retrieving a task description for at least one of the one or more media processing tasks, the task description including one or more parameters for configuring the at least one of the one or more media processing tasks.

17. The method of claim 16, further comprising sending values for each of the one or more parameters for configuring the at least one of the one or more media processing tasks to the intermediate network device.

18. The method of claim 1, wherein at least one of the one or more media processing tasks comprises a split rendering processing task, the method further comprising receiving data representing one or more processes to be performed by the first UE device for the split rendering processing task.

19. A first user equipment (UE) device for communicating media data, the first UE device comprising:
a memory configured to store media data; and
a processing system implemented in circuitry and configured to:
establish a media communication session with a second UE device;
execute a web application to configure an intermediate network device to perform one or more media processing tasks on media data destined for the second UE device and originating from the first UE device, the intermediate network device being between the first UE device and the second UE device; and
send the media data of the media communication session destined for the second UE device to the intermediate network device to cause the intermediate network device to perform the one or more media processing tasks on the media data.

20. A first user equipment (UE) device for communicating media data, the first UE device comprising:
means for establishing a media communication session with a second UE device;
means for executing a web application to configure an intermediate network device to perform one or more media processing tasks on media data destined for the second UE device and originating from the first UE device, the intermediate network device being between the first UE device and the second UE device; and
means for sending the media data of the media communication session destined for the second UE device to the intermediate network device to cause the intermediate network device to perform the one or more media processing tasks on the media data.
